(19) United States
(12) Patent Application Publication
(10) Pub. No.: US 2008/0317071 A1
(43) Pub. Date: Dec. 25, 2008

(54) Dual-Single-Frequency Fiber Laser and Method

(75) Inventors: Weihua Guan, Rochester, NY (US); John R. Marciante, Webster, NY (US)

Correspondence Address: BOND, SCHOENECK & KING, PLLC, 10 BROWN ROAD, SUITE 201, ITHACA, NY, 14850-1248, US

(73) Assignee: UNIVERSITY OF ROCHESTER, Rochester, NY (US)

(21) Appl. No.: 11/765,645

(22) Filed: Jun. 20, 2007

(51) Int. Cl. H01S 3/067

(52) U.S. Cl. 372/6

(57) ABSTRACT

An embodiment of the invention is directed to a dual-single-frequency fiber laser. A linear cavity formed by a short length of highly doped optical waveguide with distributed Bragg reflectors (DBRs) at respective ends, one of which is a polarization-maintaining PM-DBR, and a suitable pump source, provides orthogonally polarized dual-single-frequency laser emissions. Operating characteristics of the laser may be customized by appropriate design of the PM-DBR. Wavelength spacing between dual lasing wavelengths can be controlled via the birefringence parameters of the PM-DBR. Laser emission wavelengths may be controlled as a function of the period of the PM-DBR. Output power may be scaled upward by optimizing the PM-DBR reflectance and via pump power adjustment. Relaxation-oscillation effects (noise peaks) may be reduced by using a negative-feedback circuit on the pump laser. The use of a polarization-filtering component in regard to the orthogonal polarizations of the dual emissions enable laser operation in a single-polarization-single-frequency regime.

### FEDERALLY SPONSORED RESEARCH

This invention was made with government support under Cooperative Agreement No. DE-FC52-92SF19460 sponsored in part by the U.S. Department of Energy Office of Inertial Confinement Fusion. The government has certain rights in the invention.

### RELATED APPLICATION DATA

None.

### BACKGROUND

1. Field of the Invention

Embodiments of the invention are most generally related to the field of fiber lasers. More particularly, embodiments of the invention are directed to a dual-single-frequency fiber laser and a method for generating a dual-single-frequency fiber laser emission.

2. Background Discussion

Fiber lasers have garnered attention as alternatives to solid-state and semiconductor lasers because of their advantages of, e.g., high reliability, thermal management, scalable output power, high beam quality, narrow bandwidth, and low noise floor. ‘Dual wavelength’ fiber lasers are attractive for applications in ranging, communications, and interferometers. They have been reported, e.g., with a high-birefringence fiber Bragg grating (FBG) in a ring cavity, a high-birefringence FBG in a linear cavity, a multimode FBG in a linear cavity, self-seeded multimode Fabry-Perot (FP) laser diodes, dual-FBGs with a circulator in a ring cavity, multiple bandpass filters in a ring cavity, and FBGs with multiple phase shifts in linear or ring cavities. The reported dual-wavelength lasers, however, typically operate in a multimode (and, therefore, multiple frequency) regime at each of the dual-wavelengths.

In view of the foregoing considerations and others that are appreciated by persons skilled in the art, the inventors have recognized a need for a ‘dual-single-frequency’ fiber laser, especially one that could be assembled and operated with relatively inexpensive and non customized components, a method for generating a dual-single-frequency fiber laser emission, especially a tunable dual-single-frequency fiber laser emission, and the benefits and advantages associated therewith.

### SUMMARY OF THE INVENTION

An embodiment of the invention is directed to a dual-single-frequency fiber laser. The laser has a linear cavity including an active optical fiber lasing medium of length, L, extending between a first (input) end and a second (output) end of the active fiber, and an appropriate reflector coupled to the active fiber at the respective ends thereof to form the linear lasing cavity. The reflectors are distributed Bragg reflectors (DBRs), at least one of which is a polarization-maintaining DBR (PM-DBR). The laser also includes an appropriate pump source (or sources) having an output coupled into the laser cavity (fiber core or cladding, as appropriate). The length of the active fiber medium (and thus the laser cavity) is advantageously relatively short; in any case about 10 centimeters (cm) or less. In an aspect, L is substantially 3 cm or less, and in a particular aspect, 1≦L≦2 cm. In an exemplary aspect, L=1.5 cm. It will be appreciated by one skilled in the art that as L decreases, the rare earth doping concentration must increase; however, when a maximum doping concentration is not sufficient, the fiber length may need to be increased. According to a desirable aspect, L is decreased to the extent possible such that the gain/length product of the active medium is sufficient to reach a lasing threshold. In a particular aspect, the other DBR is a single-mode DBR (SM-DBR). According to a particularly advantageous aspect, the DBRs are fiber Bragg gratings (FBGs). In an illustrative aspect, a PM-FBG is fusion spliced to the output end of the active fiber and a SM-FBG is fusion spliced to the input end of the active fiber to form the linear cavity. According to various aspects, at least one of the PM-DBR and the DBR has a reflectance value, R, equal to or greater than 90%; the PM-DBR has a reflectance bandwidth (FWHM) less than or substantially equal to 0.1 nanometer; and the PM-DBR has a birefringence value sufficient to create a center-to-center peak spacing greater than or substantially equal to 0.2 nanometer. In alternative aspects, the DBRs may be thin film stacks deposited on the fiber ends as known in the art. In an exemplary aspect, the active fiber medium is a high concentration ytterbium doped silica glass fiber. In alternative aspects, the fiber may be doped with other typical rare earth materials including, but not necessarily limited to, erbium, holmium, thulium, praseodymium, neodymium; and the fiber may be a fluoride-based material, a phosphate-based material, or other optical waveguide material as appropriately known by a person skilled in the art. The output of the fiber laser will consist of two, spaced-apart wavelengths (λ₁, λ₂), wherein the two laser outputs are each single-mode, single frequency, orthogonally polarized outputs. According to a further advantageous aspect, all of the components of the embodied fiber laser described herein may be commercially available “off the shelf” components, thus benefiting assembly time, reliability, vendor selection, cost efficiency, and others considerations that will be appreciated by those skilled in the art.

Another embodiment according to the invention is directed to a method for generating a dual-single-frequency laser emission from a fiber laser. The method involves the steps of providing a linear cavity fiber laser according to one or more of the aspects described immediately above; adjusting the pump power output as a control mechanism to generate the desired dual-single-frequency laser emission and, if necessary or desirable, thermally adjusting one or both of the distributed cavity reflectors such that the ratio of the reflectance amplitude of the SM-DBR at a first wavelength of interest, R_{S}(λ₁), divided by the reflectance amplitude of the SM-DBR at a second wavelength of interest, R_{S}(λ₂), is sufficient to yield lasing in dual frequency operation with the desired ratio of power between the two frequencies; and, providing means for detecting the generation of a dual-single-frequency laser emission from the fiber laser. According to an exemplary aspect, the ratio R_{S}(λ₁)/R_{S}(λ₂) may be between 0.8 to 1.2 to obtain substantially equivalent powers in each of the dual wavelengths.

The foregoing and other objects, features, and advantages of embodiments of the present invention will be apparent from the following detailed description of the preferred embodiments, which makes reference to several drawing figures.

### BRIEF DESCRIPTION OF THE DRAWINGS

FIG. 1 is a schematic representation of a dual-single-frequency fiber laser according to an exemplary embodiment of the invention;

FIG. 2 is a plot of a measured transmission spectrum of a PM-FBG using an ASE source according to an exemplary embodiment of the invention;

FIG. 3 is a plot showing the main reflectance bandwidth of an illustrative single-mode FBG (SM-FBG) and the dual reflectance spectra of an illustrative polarization-maintaining FBG within the SM-FBG reflectance bandwidth according to an exemplary embodiment of the invention;

FIG. 4 is a plot showing the optical spectrum of a dual-single-frequency fiber laser according to an exemplary embodiment of the invention;

FIG. 5 is a scanning Fabry-Perot spectrometer plot showing the measured output spectrum of a dual-single-frequency fiber laser according to an exemplary embodiment of the invention;

FIG. 6 is an illustrative plot showing the single mode spacing within the 3 dB reflection bandwidth of a PM-FBG according to an exemplary embodiment of the invention;

FIG. 7 is a plot showing the relative intensity noise (RIN) spectrum of the respective dual wavelength laser emissions as well as both wavelengths simultaneously according to an exemplary embodiment of the invention; and

FIG. 8 is a plot of pump current versus output peak power of the dual-single-frequency laser according to an exemplary embodiment of the invention.

### DETAILED DESCRIPTION OF A PREFERRED EMBODIMENT OF THE INVENTION

The terminology “dual-single-frequency” as used herein in relation to apparatus and method embodiments of the invention shall be understood to refer to a spectrum consisting of two separated laser emission spectra centered at wavelengths λ₁, λ₂, respectively, wherein the bandwidth of each emission spectrum encompasses essentially a single frequency (and thus represents single mode emission of each spectrum), further wherein each respective dual-single-frequency emission has a different relative polarization (e.g., orthogonal relationship).

FIG. 1 shows a dual-single-frequency fiber laser 100 according to an exemplary embodiment of the invention. The components labeled PM (power meter), PD (photodetector), ESA (electrical spectrum analyzer), OSA (optical spectrum analyzer), and FP (Fabry-Perot spectrometer) are ancillary measurement devices that do not form a part of this embodiment of the invention per se.

A length, L, of highly ytterbium-doped SM single clad silica glass fiber 102 (referred to herein as the active fiber medium) having an absorption rate of 1700 dB/m at 976 nm is spliced between two fiber Bragg gratings (FBGs) 108, 110. At least one of the FBGs is a polarization-maintaining FBG (PM-FBG) (O/E Land Inc., QC Canada). In the exemplary embodiment L=1.5 cm as measured between a first, input end 104 of the active fiber and a second, output end 106 of the active fiber. The laser emission output direction of the device 100 is indicated by the arrow 111. As shown, a single-mode FBG (SM-FBG) 108 is fusion spliced to the input end 104 of the active fiber and a PM-FBG 106 is fusion spliced to the output end 106 of the active fiber. The SM-FBG 108 has a center wavelength of 1029.3 nm and a 3 dB bandwidth of 0.46 nm with a peak reflectivity of 99%. At least one of the FBGs should have a peak reflectivity equal to or greater than 90%. Each of the FBGs has a grating section length of about 3 mm. Thus the exemplary linear laser cavity formed by the active fiber medium and the two end reflectors has a total cavity length of about 2.1 cm. A wavelength-division multiplexer 112 is used to couple 976 nm single-spatial-mode pump light 114 from a pump laser 116 into the core of the active fiber medium.

It is to be appreciated that, according to an embodiment of the invention, it is intended that the laser output is dual-single-frequency, as that term is described hereinabove. In view thereof, the component arrangements and specification parameters described in regard to the exemplary device shown in FIG. 1 may vary, as one of ordinary skill in the art will understand. For example, the active fiber medium 102 may be doped with other known rare earth materials including, but not necessarily limited to, holmium, thulium, praseodymium, neodymium, and erbium. Likewise, the fiber may be a fluoride-based, phosphate-based, or other appropriate optical waveguide material suitable for use as a fiber laser, including an appropriate pump source and pumping configuration for generating lasing action.

What is particularly important as well as being particularly desirable, is that the active fiber medium length, L, be relatively short and, in any case, less than substantially 10 cm. More advantageously, L≦3 cm. One skilled in the art will appreciate that the limiting condition is that the gain/length product of the active medium be sufficient to achieve lasing threshold within the constraint of L≦10 cm. Furthermore, the PM-FBG need not be located at the output end (vs. the input end) of the cavity, nor must the SM-FBG be a ‘single-mode’ FBG, as long as at least one of the FBGs 108, 110 is a PM-FBG.

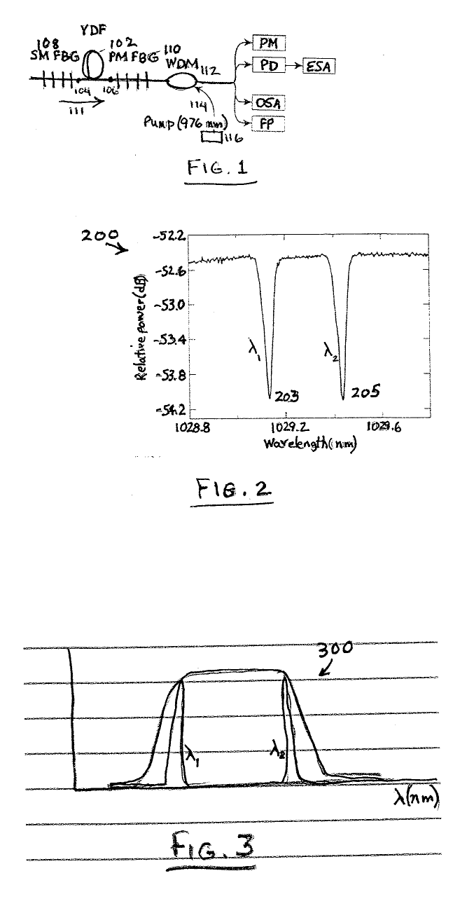

FIG. 2 shows the measured transmission spectrum 200 of the exemplary PM-FBG 110 when seeded with an unpolarized amplified spontaneous emission (ASE) source. Because of the differential modal refractive index along the fast and slow axes, the grating exhibits two peak-reflection wavelengths 203, 205; one for each polarization. The peak-reflection wavelengths in this example are at λ₁=1029.1 nm and λ₂=1029.4 nm. Both of the peak reflectivity wavelengths 203, 205 lie within the reflection band 300 of the SM-FBG 108 under ambient-temperature conditions as shown in FIG. 3. Each of the reflection bands 203, 205 of the PM-FBG 110 has a 3 dB bandwidth of 0.06 nm and a 55% reflectivity for the corresponding polarizations. According to an aspect, each of the reflection bands 203, 205 of the PM-FBG 110 will have a 3 dB bandwidth substantially equal to or less than 0.1 nm.

The gain competition between polarizations at these two wavelengths determines the spectral properties of the laser. In ytterbium-doped fiber lasers, the ytterbium can be treated as a special homogenous broadening medium and thus permits only a single lasing mode. In a linear cavity, however, a standing wave will be formed between the two reflectors and thus spatial-hole burning (SHB) occurs. Additionally, polarization-hole burning (PHB) is similar to SHB in the sense that different polarizations will extract different gains from the active medium and, thus, affect lasers with birefringent components. Furthermore, gain saturation enhances the dual-frequency lasing through the modal competition process. Generally, the combined effects of SHB, PHB, gain saturation, thermal effects, and nonlinearities determine the modal behaviors of the fiber lasers.

### Experimental Results

An output power of 43 mW was achieved with the fiber laser setup depicted in FIG. 1 when supplied with 490 mW of pump power, with lasing threshold at 10 mW of pump power. The optical signal-to-noise ratio (OSNR) was measured with an optical spectrum analyzer (OSA) using a 0.01 nm bandwidth. At an output power of 43 mW, the OSNR was greater than 60 dB, as shown in FIG. 4. In the exemplary dual-single-frequency fiber laser as shown in FIG. 1, the OSNR is limited by residual ASE noise. No other lasing modes were observed over the entire ytterbium gain band. The wavelength spacing of the dual-single-frequency fiber laser is determined by the differential refractive index along the fast and slow axes of the PM-FBG. Accordingly, the wavelength spacing can be designed by writing the grating into PM fiber of suitable birefringence.

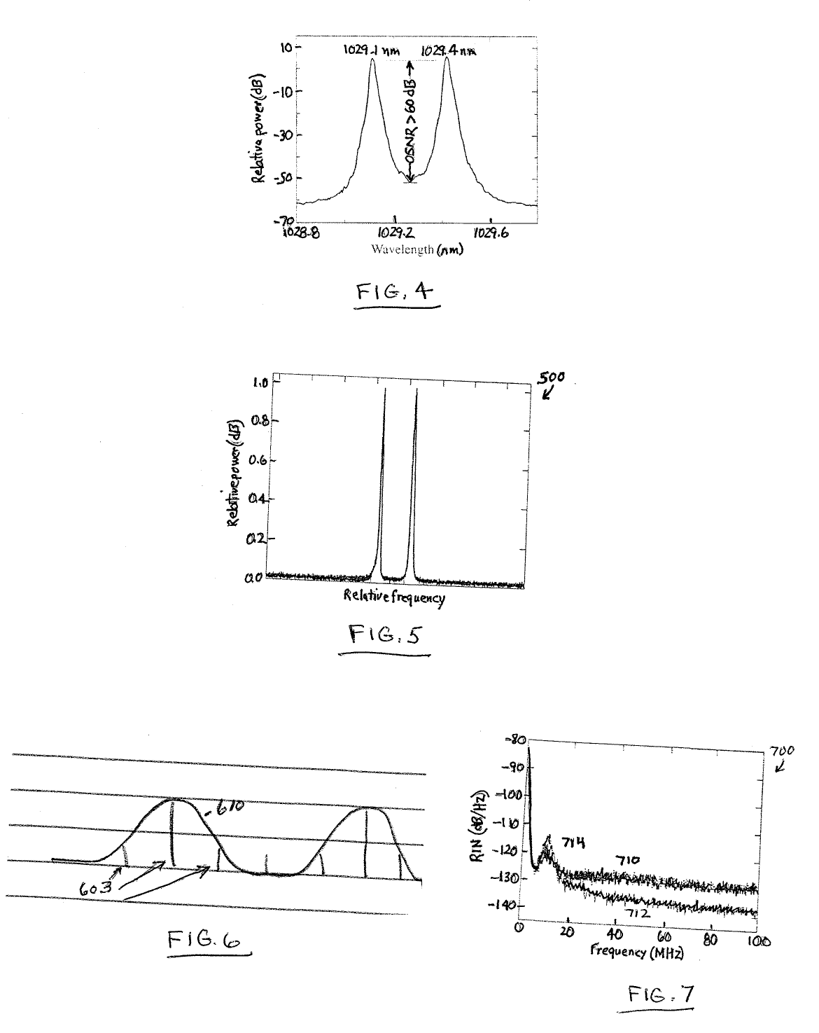

The single-mode (SM) operation at each lasing wavelength λ₁, λ₂ was verified with a Fabry-Perot spectrometer (FP, FIG. 1). FIG. 5 shows the scanning spectrum 500 of the laser modes at an output power equal to 43 mW. The free spectral range is 150 GHz. With a finesse of 150, the FP spectrometer has a resolution of 1 GHz. Since the fiber laser has a substantially 2 cm long cavity, corresponding to 5.1 GHz in modal frequency spacing, the multiple modes caused by the fiber laser cavity could be well resolved by the FP spectrometer. Although three FP modes 603 can be supported within the 3 dB reflection band of the PM-FBG as schematically illustrated in FIG. 6, the curvature of the PM-FBG reflection spectrum 610 provides large longitudinal mode discrimination enabling only a single-mode to lase in each polarization. During the experimental measurements, no mode hopping was observed.

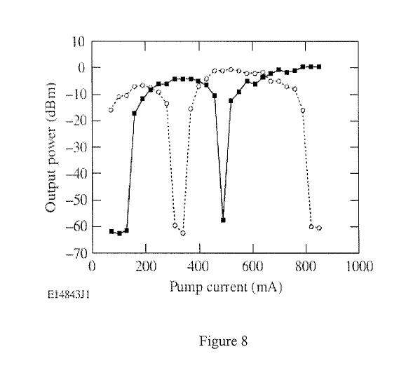

The relative intensity noise (RIN) was measured using an electrical spectrum analyzer (ESA, FIG. 1). The measurement was limited by the bandwidth of the photodiode detector (PD, FIG. 1) having a cutoff frequency of 1 GHz. The FP cavity was used to filter out each wavelength by applying a bias voltage but not a scanning signal. In this way, the RIN at each wavelength could be independently measured. FIG. 7 shows plots 710, 712 of the RIN of each filtered lasing wavelength and the RIN of the total laser output with both wavelengths 714 with the laser set to 43 mW output power. In the three cases, the RIN is limited by the shot noise beyond 60 MHz. The noise peak at the frequency of 10 MHz is caused by relaxation oscillations of the fiber laser. This is in agreement with theoretical calculations using the measured upper state lifetime of 0.17 ms for the exemplary highly ytterbium-doped fiber. The RIN floor of the individual channels is higher than that of the total laser due to the optical power reduction caused by the FP cavity filter that was used to separate the wavelengths.

The polarization states of the exemplary dual-single-frequency fiber-laser output were measured with a quarter-wave plate and a polarizer. Each frequency exhibited a single polarization with a polarization excitation ratio of >20 dB. The two polarizations states are orthogonal, as expected from the PM-FBG. Since the FBG spectra were aligned at room temperature, dual-wavelength operation with two orthogonal polarizations could be achieved independent of ambient temperature. This may not generally be true if a temperature controller was necessary to align the two FBG spectra. Differential output peak powers could be generated by tuning the temperature of the FBGs differently. As the overlapping of the FBG spectra is changed by thermal tuning, the round-trip gain of the laser at two lasing frequencies will be changed and differential output peak power can be generated.

The exemplary dual-single-frequency laser demonstrated stable operation under perturbations of pump power. In the working regime, where the output power was on the order of 43 mW, the measured ratio of peak power at each wavelength changed with the pump current as 0.02 dB/mA. Therefore, a 1% change in pump power would lead to a 5% change in relative peak power. Practically, pump-power can be suitably controlled with commercial diode laser drivers to better than 0.01%, which would provide less than a 0.05% relative peak-power variation between the two fiber laser wavelengths. Thus the embodied dual-single-frequency fiber laser generated a highly stable output.

According to various aspects of the apparatus and method embodiments described herein, operating characteristics of the dual-single-frequency fiber laser may be customized by appropriate design and/or selection of the PM-FBG. Wavelength spacing between the dual lasing wavelengths can be controlled via the birefringence parameters of the PM-FBG. Laser emission wavelengths may be controlled as a function of the period of the both FBG's. Output power of the dual-single-frequency fiber laser may be scaled upward by optimizing the PM-FBG reflectance and via pump power adjustment. FIG. 8 shows a curve of pump current versus output peak power of the dual-single-frequency laser according to an exemplary embodiment. Dual frequency switching can be observed as the pump power of the laser is tuned. The laser output measured with an OSA and F-P cavity indicates a clear switching property. The laser shows substantially equal powers at two lasing peaks when the pump current is 250 mA, 430 mA or 640 mA. The output power ratio at two lasing wavelengths differs at other pump currents. The peak power as a function of the pump current has been shown in the figure. The pump current can be selected to generate a single-frequency or dual-frequency output. In the single frequency working regime, the laser demonstrated an OSNR greater than 50 dB.

Relaxation-oscillation effects (noise peaks) may be reduced by using, e.g., a negative-feedback circuit on the pump laser. The use of a polarization-filtering component in regard to the orthogonal polarizations of the dual emission will further enable the dual-single-frequency fiber laser to work in a single-polarization-single-frequency regime.

The foregoing description of the embodiments of the invention have been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A dual-single-frequency fiber laser, comprising:
a linear cavity comprising a length, L, of an active fiber medium, characterized by a gain/length product sufficient to reach a lasing threshold, wherein the length, L, between a first, input end and a second, output end is less than or substantially equal to 10 centimeters;
a polarization-maintaining distributed Bragg reflector (PM-DBR) coupled to one of the first and second ends of the active fiber;
a distributed Bragg reflector (DBR) coupled to one of the second and first ends, respectively, of the active fiber; and
at least one active medium pump source having an output coupled into the active fiber medium.

2. The fiber laser of claim 1, wherein the dual-single-frequency fiber laser has a wavelength tuning mechanism.

3. The fiber laser of claim 1, wherein L is less than or substantially equal to 3 centimeters.

4. The fiber laser of claim 1, wherein 1≦L≦2 centimeters.

5. The fiber laser of claim 1, wherein the active fiber medium is a rare earth doped optical waveguide.

6. The fiber laser of claim 5, wherein the active fiber medium is a ytterbium-doped optical waveguide.

7. The fiber laser of claim 5, wherein the active fiber medium is a thulium-doped optical waveguide.

8. The fiber laser of claim 5, wherein the active fiber medium is a holmium-doped optical waveguide.

9. The fiber laser of claim 5, wherein the active fiber medium is one of a neodymium-doped and a samarium-doped and an erbium-doped and a praseodymium-doped optical waveguide.

10. The fiber laser of claim 5, wherein the active fiber medium is a silica-based fiber.

11. The fiber laser of claim 5, wherein the active fiber medium comprises a phosphate-based fiber.

12. The fiber laser of claim 5, wherein the active fiber medium comprises a fluoride-based fiber.

13. The fiber laser of claim 1, wherein the at least one pump source is forward-coupled into at least one of a core and a cladding of the active fiber.

14. The fiber laser of claim 1, wherein the pump source is reverse-coupled into at least one of a core and a cladding of the active fiber.

15. The fiber laser of claim 1, wherein the at least one pump source is end-coupled into the active fiber.

16. The fiber laser of claim 1, wherein the at least one pump source is bidirectionally-coupled into at least one of a core and a cladding of the active fiber.

17. The fiber laser of claim 1, wherein the PM-DBR is a PM-fiber Bragg grating (PM-FBG).

18. The fiber laser of claim 17, wherein the PM-FBG is connected to the second end of the active fiber.

19. The fiber laser of claim 1, wherein the DBR is one of a PM-FBG and a single-mode fiber Bragg grating (SM-FBG).

20. The fiber laser of claim 18, wherein the DBR is a SM-FBG that is connected to the first end of the active fiber.

21. The fiber laser of claim 1, wherein the PM-DBR and the DBR are fusion spliced to respective ends of the active fiber.

22. The fiber laser of claim 1, wherein at least one of the PM-DBR and the DBR has a reflectance value, R, equal to or greater than 90%.

23. The fiber laser of claim 1, wherein the PM-DBR has a (FWHM) reflectance bandwidth less than or substantially equal to 0.1 nanometer.

24. The fiber laser of claim 1, wherein the PM-DBR has a birefringence value sufficient to create a center-to-center peak spacing greater than or substantially equal to 0.2 nanometer.

25. The fiber laser of claim 1, wherein the PM-DBR and the DBR are stacked thin film reflectors incorporated into the respective ends of the active fiber.

26. The fiber laser of claim 1, having a laser output at only two, spaced-apart wavelengths (λ₁, λ₂), wherein each of the two laser outputs are characterized as single-mode, single frequency outputs.

27. The fiber laser of claim 26, wherein the two laser outputs have orthogonal polarizations.

28. A dual-single-frequency fiber laser, comprising:
a linear cavity comprising a length, L, of a rare earth element-doped core silica glass fiber, having a gain/length product sufficient to reach a lasing threshold, wherein L≦10 centimeters;
two fiber Bragg gratings (FBGs) respectively incorporated at a first, input end and at a second, output end of the doped silica fiber, wherein at least one of the FBGs is a polarization-maintaining (PM) FBG; and
an active medium pump source having a single mode output coupled into one of the doped fiber core and the doped fiber cladding.

29. The fiber laser of claim 28, wherein L≦3 centimeters.

30. The fiber laser of claim 29, wherein 1≦L≦2 centimeters.

31. The fiber laser of claim 28, wherein the at least one PM-FBG is spliced to the second, output end of the doped fiber.

32. The fiber laser of claim 31, wherein the other one of the FBGs is a single mode (SM) FBG spliced to the first, input end of the doped fiber.

33. The fiber laser of claim 28, wherein the PM-FBG has a reflectance bandwidth (FWHM) less than or substantially equal to 0.1 nanometer.

34. A method for generating a dual-single-frequency laser emission, comprising the steps of:
providing a linear cavity fiber laser including an active fiber medium, characterized by a gain/length product sufficient to reach a lasing threshold, said fiber having a length, L, between a first, input end and a second, output end that is less than or substantially equal to 10 centimeters, a polarization-maintaining distributed Bragg reflector (PM-DBR) coupled to one of the first and second ends of the active fiber, and, a single-mode distributed Bragg reflector (SM-DBR) connected to one of the second and first ends, respectively, of the active fiber, and at least one active medium pump source having an adjustable power output coupled into the active fiber medium,
providing a detection indicia of dual-single-frequency laser emission;
detecting dual-single-frequency laser emission by adjusting the pump power; and
thermally adjusting, as necessary, at least one of the PM-DBR and SM-DBR such that the ratio of the reflectance amplitude of the SM-DBR at a first wavelength of interest, R_{S}(λ₁), divided by the reflectance amplitude of the SM-DBR at a second wavelength of interest, R_{S}(λ₂), is sufficient to yield lasing in dual frequency operation with a desired ratio of power between the two frequencies, where R_{S}(λ₁) is the reflectance amplitude of the SM-DBR at a first wavelength of interest and R_{S}(λ₂) is the reflectance amplitude of the SM-DBR at a second wavelength of interest.

35. The method according to claim 34, comprising thermally adjusting the at least one of the PM-DBR and SM-DBR such that the value of R_{S}(λ₁)/R_{S}(λ₂) is between 0.8 to 1.2.

36. The method according to claim 34, comprising operating the linear cavity fiber laser at room-temperature.

37. The method according to claim 34, comprising tuning the wavelengths of the dual-single-frequency laser emission.
